(19) United States
(12) Patent Application Publication
(10) Pub. No.: US 2023/0418647 A1
(43) Pub. Date: Dec. 28, 2023

(54) PROVIDING NAME RESOLUTION SERVICES TO COMPONENTS EXECUTING IN A VIRTUALIZED ENVIRONMENT

(71) Applicant: MICROSOFT TECHNOLOGY LICENSING, LLC, Redmond, WA (US)

(72) Inventors: Keith Edgar HORTON, North Bend, WA (US); Alan Thomas Gavin JOWETT, Eagle MT, UT (US); Andrew Mario BELTRANO, Colorado Springs, CO (US); Catalin-Emil FETOIU, Redmond, WA (US); Guillaume Philippe Adrien HETIER, Redmond, WA (US); Matthew Yutaka IGE, Seattle, WA (US); Mitchell James SCHMIDT, Bellevue, WA (US); Randy Joseph MILLER, Newcastle, WA (US)

(21) Appl. No.: 17/852,171

(22) Filed: Jun. 28, 2022

(51) Int. Cl. G06F 9/455; G06F 9/54; H04L 61/4511

(52) U.S. Cl. CPC G06F 9/45558; G06F 9/541; H04L 61/4511; G06F 2009/45595

(57) ABSTRACT

Technologies are disclosed for providing name resolution services to components executing in a virtualized environment. A name resolution request generated by a component executing within a virtualized environment is intercepted and forwarded from the virtualized environment to a host operating system (“OS”). A user process is then executed that requests that the host OS resolve a name specified by the intercepted name resolution request. Once the user process has received a response to the name resolution request made to the host OS, a response to the original name resolution request made by the component executing within the virtualized environment can be generated based on the response received by the user process. The response to the original name resolution request can then be provided to the component executing in the virtualized environment that requested name resolution.

### BACKGROUND

Software components executing within and outside of virtualized environments, such as virtual machines (“VMs”) and containers, commonly utilize name resolution services. Name resolution is a process for resolving the name of a computer into its corresponding numeric network address. Name resolution services are commonly provided by operating systems and network services.

For various reasons, it is generally desirable for software components executing within a virtualized environment to operate in the same manner that they would if they were to be executed directly on the host that provides the virtualized environment. For example, when utilizing name resolution services to resolve a name, a component executing in a virtualized environment would ideally receive the same network address that the component would receive if it were executing directly on the host implementing the virtualized environment.

It is, however, currently possible for names to be resolved for software components executing in virtualized environments differently than they would if the software components were executing directly on a host. This inconsistency can lead to various technical problems, including network security issues caused by a lack of enforcement of name resolution policy. It is with respect to these and other technical challenges that the disclosure made herein is presented.

### SUMMARY

Technologies are disclosed herein for providing name resolution services to components executing in a virtualized environment. Through implementations of the disclosed technologies, a component executing in a virtualized environment that makes a name resolution request will receive the same network address in response thereto that the component would receive if it were executing directly on the host implementing the virtualized environment.

Name resolution policy defined on a host can also be applied to name resolution requests made by components executing in a virtualized environment. This can improve network security by ensuring that the same name resolution policy is applied to name resolution requests originating within a virtualized environment and those originating from components executing directly on the host. Other technical benefits not specifically mentioned herein can also be realized through implementations of the disclosed subject matter.

In order to provide aspects of the functionality disclosed herein, a component is executed in a virtualized environment that intercepts name resolution requests generated by other components executing within the virtualized environment, such as applications or operating system (“OS”) components. For example, network packets containing name resolution requests generated by components executing within the virtualized environment may be intercepted.

In an embodiment, network packets containing name resolution requests are identified based upon a protocol and port number specified by the network packets. For example, network packets utilizing the Transmission Control Protocol (“TCP”) or the User Datagram Protocol (“UDP”) might be identified as containing name resolution requests based upon a protocol and port number. Network packets containing name resolution requests might also be identified based upon other types of data, including a guest name resolution policy defined by a guest OS executing in the virtualized environment.

In an embodiment, network packets including name resolution requests are intercepted at a location in the virtualized environment between a bond interface and a virtual network adapter. Network packets that include name resolution requests can be intercepted at other locations within a virtualized environment in other embodiments.

Intercepted name resolution requests are forwarded from the virtualized environment to a host OS. A component in the host OS then processes the network packet received from the virtualized environment to realize the intended name resolution request from the guest that originated the network packet. The component in the host OS then interprets the realized requested name from the network packet and makes an analogous application programming interface (“API”) call on the host to perform the name resolution for the realized name.

In an embodiment, the component in the host OS spawns a user process that requests that the host OS resolve the name specified by the intercepted name resolution request. For example, in an embodiment the user process requests resolution of the name by making an API call to a name resolution API provided by the host OS. The user process may be associated with an account that is associated with execution of the component that generated the name resolution request to execute in the virtualized environment.

In an embodiment, the name resolution API consults a name resolution policy when processing name resolution requests. In this embodiment, the same name resolution policy is applied to name resolution requests originating from within the virtualized environment and those originating from components executing on the host. In this manner, responses to name resolution requests will be the same whether they originated from components executing in the virtualized environment or components executing directly on a host. The name resolution policy can be specified on a per-user account basis, a per-application basis, a per-interface basis, or on another basis, according to various embodiments.

Once the user process has received a response to the name resolution request made to the host OS, a response to the original name resolution request made by the component executing within the virtualized environment can be generated based on the response received by the user process. For example, a network packet can be generated that includes a response to the request to resolve the name, including the resolved network address. The network packet can then be provided to the component executing in the virtualized environment that requested name resolution in response to the original request.

It should be appreciated that the above-described subject matter can be implemented as a computer-controlled apparatus, a computer-implemented method, a computing device, or as an article of manufacture such as a computer readable medium. These and various other features will be apparent from a reading of the following Detailed Description and a review of the associated drawings.

This Summary is provided to introduce a brief description of some aspects of the disclosed technologies in a simplified form that are further described below in the Detailed Description. This Summary is not intended to identify key features or essential features of the claimed subject matter, nor is it intended that this Summary be used to limit the scope of the claimed subject matter. Furthermore, the claimed subject matter is not limited to implementations that solve any or all disadvantages noted in any part of this disclosure.

### BRIEF DESCRIPTION OF THE DRAWINGS

FIG. 1 is a computing system architecture diagram showing aspects of an example operating environment for the technologies disclosed herein, according to an embodiment;

FIG. 2A is a computing system architecture diagram showing aspects of an example mechanism disclosed herein for intercepting name resolution requests and forwarding the name resolution requests to a host, according to an embodiment;

FIG. 2B is a computing system architecture diagram showing aspects of an example mechanism disclosed herein for generating a response to a name resolution request on a host and returning the response to a requesting component executing in a virtualized environment, according to an embodiment;

FIG. 3A is a flow diagram showing a routine that illustrates aspects of the example mechanism shown in FIG. 2A for intercepting name resolution requests and forwarding the name resolution requests to a host, according to an embodiment;

FIG. 3B is a flow diagram showing a routine that illustrates aspects of the example mechanism shown in FIG. 2B for generating a response to a name resolution request on a host and returning the response to a requesting component executing in a virtualized environment, according to an embodiment;

FIG. 4 is a computer architecture diagram showing an illustrative computer hardware and software architecture for a computing device that can implement aspects of the technologies presented herein; and

FIG. 5 is a network diagram illustrating an example distributed computing environment in which aspects of the disclosed technologies can be implemented.

### DETAILED DESCRIPTION

The following detailed description is directed to technologies for providing name resolution services to components executing in a virtualized environment. As discussed briefly above, various technical benefits can be realized through implementations of the disclosed technologies, such as improving network security and providing consistent name resolution functionality to components executing within a virtualized environment and other components executing outside the virtualized environment. Other technical benefits not specifically mentioned herein can also be realized through implementations of the disclosed subject matter.

As discussed briefly above, virtualization technologies enable the creation of an abstraction layer over physical hardware that allows a single computer, commonly referred to as a “host” or a “host processing system,” to provide multiple isolated virtualized environments, commonly referred to as “guests,” that can execute an OS and other programs independently from the host. Examples of virtualized environments include VMs and containers.

In virtualized environments, guests commonly execute an isolated OS that is fully independent of the OS executing on the host. This creates a deployment where applications and other components deployed into the guest can run in the OS environment for which they were originally designed, regardless of the OS executing on the host. This also allows applications executing in a guest to appear to a user as if they were running on the host directly.

In one specific example, for instance, a host executing one OS, such as the WINDOWS® operating system, might be configured to provide a virtualized environment, such as a container or a VM, that executes a different OS, such as the ANDROID™ OS. In this example, applications and other components executing in the virtualized environment have access to a runtime environment that is the same as if they were executing directly on a physical device. These applications can, therefore, execute in the virtualized environment without modification. At the same time, a user of the host can see and interact with the applications as if they were running directly on the host.

Software components executing within and outside of virtualized environments commonly utilize name resolution services. As discussed briefly above, name resolution is the process of resolving the name of a computer into its corresponding network address. Name resolution services are commonly provided by operating systems and network services.

As also discussed briefly above, it is generally desirable for software components executing within a virtualized environment to operate in the same manner that they would if they were executed directly on the host providing the virtualized environment. For example, when utilizing name resolution services to resolve a name, a component executing in a virtualized environment would ideally receive the same network address that the component would receive if it were executing directly on the host implementing the virtualized environment.

It is, however, currently possible for names to be resolved for software components executing in virtualized environments differently than they would if the software components were executing directly on a host. As mentioned above, this inconsistency can lead to various technical problems, including network security issues caused by a lack of enforcement of name resolution policy.

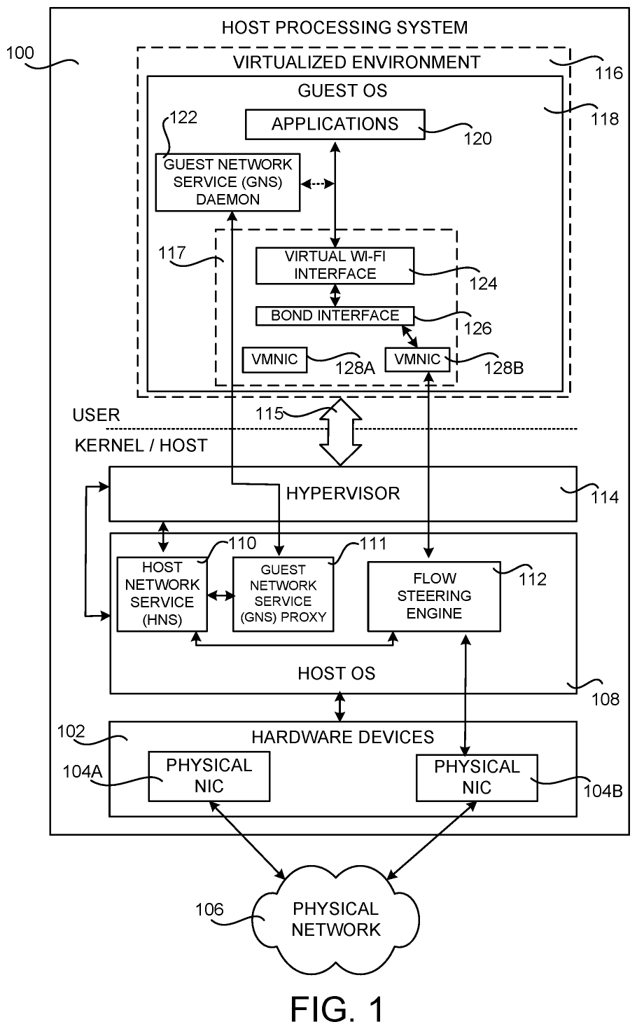

FIG. 1 is a computing system architecture diagram showing aspects of an operating environment for the technologies disclosed herein, according to an embodiment. In particular, FIG. 1 shows aspects of the configuration and operation of a host processing system 100 (referred to herein as the “host”) configured to provide a virtualized environment 116, such as a VM or a container.

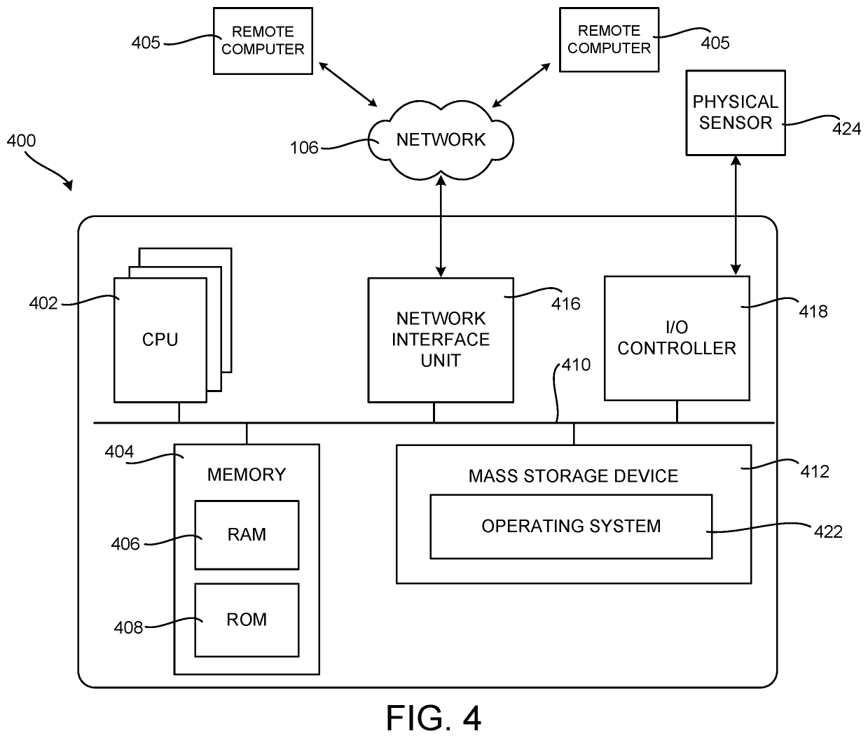

In order to provide the disclosed functionality, the host 100 includes various hardware devices 102, some of which are not illustrated in FIG. 1 for simplicity, including several physical network interface cards (referred to herein as “interfaces”) 104A and 104B. The interfaces 104A and 104B are hardware devices that provide media access to a physical network 106, such as a virtual private network (“VPN”), a wired or wireless local area network, the internet, or a cellular network. FIG. 4, described below, provides additional detail regarding some of the other hardware components that might be present in the host 100.

A host network stack (not shown in FIG. 1) handles network communications passing between the host 100 and the physical network 106 via the interfaces 104A and 104B. The host network stack typically includes appropriate layers of the Open Systems Interconnection (“OSI”) model.

As also shown in FIG. 1, the host 100 executes a host OS 108. In an embodiment, the host OS 108 is a member of the WINDOWS® family of operating systems from MICROSOFT® CORPORATION. Other operating systems from other developers might be utilized as the host OS 108 in other embodiments.

The host 100 also executes a hypervisor 114 in some embodiments. The hypervisor 114 is a software component that virtualizes hardware access for virtualized environments, such as VMs and containers. The term “hypervisor,” as used herein, is considered to include privileged host-side virtualization functionality commonly found in privileged partitions or hardware isolated virtualized environments. Virtual machine managers (“VMMs”), container engines, and kernel-based virtualization modules are some examples of hypervisors. In this regard, it is to be appreciated that the technologies disclosed herein can be utilized with other types of solutions for providing isolated access to virtualized hardware.

In the embodiment illustrated in FIG. 1, the hypervisor 114 provides support for one or more virtualized environments 116. In an embodiment, the virtualized environment 116 is a container. However, the virtualized environment 116 might be a VM or another type of hardware isolated virtualized environment in other embodiments. A cross-container communication channel 115, such as a socket-based interface, is established between the host 100 and the virtualized environment 116 in some embodiments.

As shown in FIG. 1, and described briefly above, a guest OS 118 can be executed in the virtualized environment 116. In some embodiments, the guest OS 118 is a different OS than the host OS 108. The guest OS 118 includes a complete OS kernel executing fully independently of the kernel of the host OS 108 in some embodiments.

Through virtualization, the guest OS 118 and software components executing on the guest OS 118, such as the applications 120, can execute in the virtualized environment 116 in the same manner they would if they were executing directly on the host 100 (e.g., executing on the host OS 108). The guest OS 118 and applications 120 executing on the guest OS 118 are generally unaware that they are not executing directly on physical hardware.

In an embodiment, the guest OS 118 is the ANDROID™ OS developed by the OPEN HANDSET ALLIANCE™ and commercially sponsored by GOOGLE® LLC. The ANDROID™ OS is a mobile OS based on a modified version of the LINUX® kernel and other open source software and has been designed primarily for touchscreen mobile devices such as smartphones and tablet computing devices.

In another embodiment, the guest OS 118 is the TIZEN™ OS backed by the LINUX FOUNDATION™ and mainly developed and utilized by SAMSUNG® ELECTRONICS CO., LTD. Other operating systems from other developers might be utilized as the guest OS 118 in other embodiments.

In an embodiment, an abstraction layer 117 is provided in the virtualized environment 116 that ensures that the guest OS 118 and the applications 120 and other components executing thereupon do not encounter an unsupported network configuration. In an embodiment, for example, interfaces 104A and 104B available to the host 100 are projected into the virtualized environment 116 by creating corresponding virtual network adapters 128A and 128B in the virtualized environment 116. The virtual network adapters 128A and 128B are virtual Ethernet adapters in the embodiment shown in FIG. 1 but might be implemented as other types of network adapters in other embodiments.

As shown in FIG. 1, the virtual network adapters 128A and 128B are aggregated behind a single bond interface 126. The bond interface 126 enables the combination of multiple virtual network adapters 128A and 128B into a single interface for redundancy or increased throughput. In an embodiment, the host 100 selects a single one of the virtual network adapters 128A and 128B to be active at any given time. For example, a guest network service (“GNS”) proxy 111 executing on the host 100 can informs the GNS daemon 122 of the virtual network adapter 128 that is to be used. The GNS proxy 111 then marks that interface as the active virtual network adapter 128 in the bond interface 126. A host network service (“HNS”) 110 executing on the host 100 can be queried for data identifying the current networks visible to the host 100.

In the example shown in FIG. 1, for instance, the virtual network adapter 128B, which corresponds to the interface 104B, has been set as the active interface. In this regard, it is to be appreciated that the virtual network adapters 128A and 128B in the virtualized environment 116 need not be of the same type as the interfaces 104A and 104B to which they correspond. For instance, in the illustrated example, the interface 104B might be a Wi-Fi® adapter while the virtual network adapter 128B in the virtualized environment 116 might be an Ethernet adapter.

In order to expose a compatible network interface to the guest OS 118, a virtual Wi-Fi® interface 124 is created in one embodiment and bound to the bond interface 126. The virtual Wi-Fi® interface 124 is the only network interface visible to the guest OS 118 and applications 120 in this embodiment. The virtual Wi-Fi® interface 124 and bond interface 126 forward network packets out to the currently active virtual network adapter 128A or 128B. In the example shown in FIG. 1, for instance, the virtual Wi-Fi® interface 124 forwards packets received from applications 120 and the guest OS 118 to the virtual network adapter 128B.

In embodiments where the guest OS 118 is the ANDROID′ OS, exposing only a single virtual Wi-Fi® interface 124 to the guest OS 118 and applications 120 ensures compatibility by ensuring the guest OS 118 and applications 120 will not encounter an Ethernet interface or multiple Wi-Fi® interfaces. In this regard, it is to be appreciated that the interface 124 exposed to the guest OS 118 and applications 120 might be another type of interface in other embodiments. For example, if a guest OS 118 does not provide support for Wi-Fi® interfaces, a virtual Ethernet interface could be exposed to the guest OS 118 rather than the virtual Wi-Fi® interface 124 described above.

The virtual Wi-Fi® interface 124 handles control messages from APIs called by applications 120 executing on the guest OS 118. Examples of such messages include control messages for connecting to a specified network, control messages for disconnecting from a specified network, and control messages for requesting a list of available Wi-Fi® networks. The GNS daemon 122, in turn, forwards the received control messages to the GNS proxy 111 executing on the host 100.

Once the interfaces 104A and 104B have been mirrored into the virtualized environment 116 and the abstraction layer 117 has been created in the virtualized environment 116 in the manner described above, the host 100 can be configured to properly route network traffic between an interface 104 and a virtual network adapter 128 in the virtualized environment 116. For example, a flow steering engine (“FSE”) 112 is executed on the host 100 in an embodiment that forwards network packets to and from the virtualized environment 116 through a virtual switch (not shown in FIG. 1) connected to the virtualized environment 116. The FSE 112 is an OS driver in an embodiment, but might be implemented as another type of component in other embodiments.

The configuration shown in FIG. 1 is but one example of a suitable operating environment for implementing the various technologies disclosed herein. Moreover, the configuration shown in FIG. 1 and its associated description are not intended to suggest any limitation as to the scope of use or functionality of the disclosure made herein. Other suitable operating environments for the various embodiments disclosed herein will be apparent to those skilled in the art.

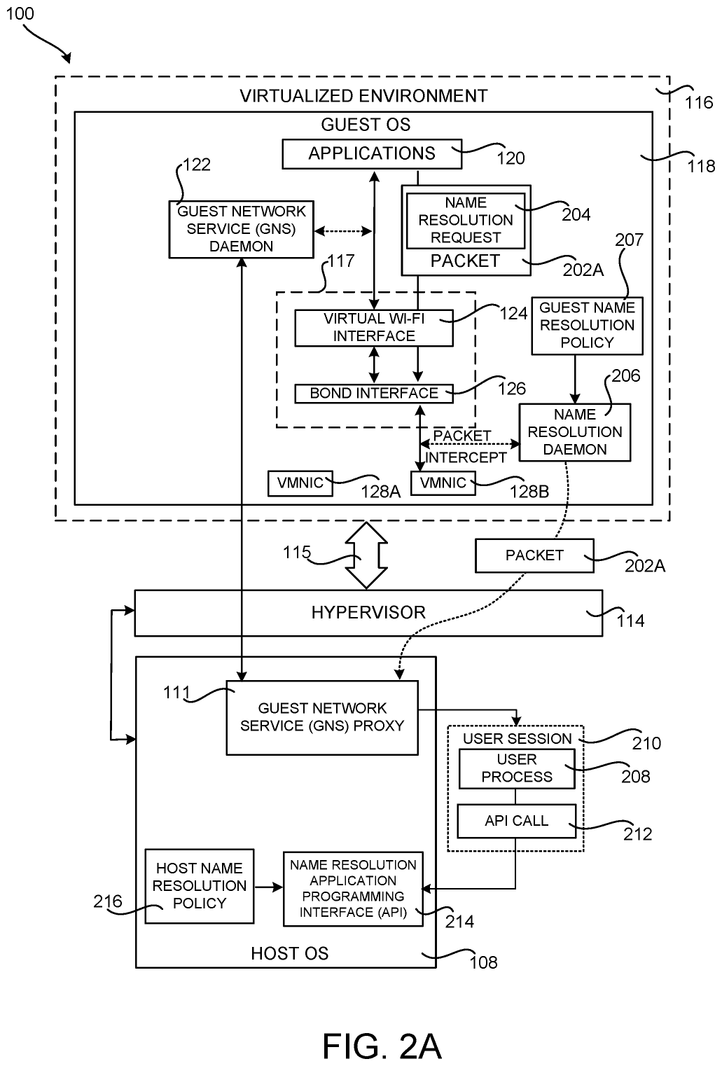

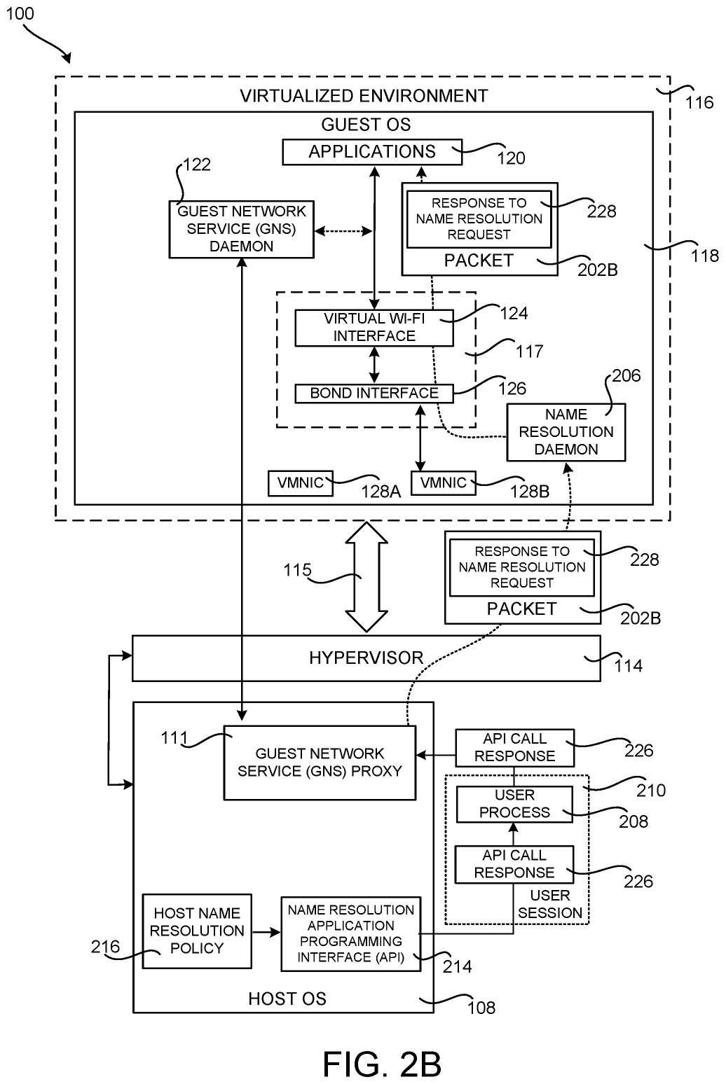

FIG. 2A is a computing system architecture diagram showing aspects of a mechanism disclosed herein for intercepting name resolution requests and forwarding the name resolution requests to a host 100 for processing, according to an embodiment. As shown in FIG. 2A, a daemon 206 (referred to herein as the “name resolution daemon”) or another type of component is executed in the virtualized environment 116 that intercepts name resolution requests 204 generated by other components executing within the virtualized environment 116, such as applications 120, services, or components of the guest OS 118. By intercepting the name resolution requests 204, the name resolution daemon 206 prevents the host OS 108, a network service, or another component from responding to the name resolution requests 204. Rather, the name resolution requests 204 are processed and responded to in the manner described below.

In an embodiment, the name resolution daemon 206 intercepts network packets 202A that contain a name resolution request 204 generated by an application 120 or another type of software component executing within the virtualized environment 116. The name resolution request 204 may be expressed using a suitable protocol such as the Domain Network System (“DNS”) protocol, the multicast DNS protocol, the network basic input/output system (“NetBIOS”) over TCP/Internet Protocol (“TCP/IP”), or another suitable protocol.

In an embodiment, the name resolution daemon 206 identifies network packets 202A containing name resolution requests 204 based upon a protocol and a port number specified by the network packets 202A. For example, in one embodiment network packets 202A that utilize TCP or UDP and that have a destination port number of 53 are identified as containing name resolution requests 204 and intercepted by the name resolution daemon 206. Other protocols and port numbers can be utilized to identify name resolution requests 204 in other embodiments.

The name resolution daemon 206 might also, or alternately, identify network packets 202A that contain name resolution requests 204 based upon other types of data. For example, in an embodiment the name resolution daemon 206 utilizes a guest name resolution policy 207 defined by the guest OS 118 executing in the virtualized environment 116 in order to identify network packets 202A containing name resolution requests 204.

The guest name resolution policy 207 specifies a policy to be used by the guest OS 118 when processing name resolution requests 204. For example, the guest name resolution policy 207 might specify that all name resolution requests are to be routed to a particular network address and port number. As another example, the guest name resolution policy 207 might specify that all web browser applications executing on the guest OS 118 are to utilize a particular network address when transmitting name resolution requests 204.

By utilizing the guest name resolution policy 207 to identify network packets 202A that contain name resolution requests 204, name resolution requests 204 generated by applications 120 that behave according to the guest name resolution policy 207 can be intercepted. In this regard, it is to be appreciated that the name resolution daemon 206 or another component might utilize other types of data and mechanisms to identify and intercept name resolution requests 204 originating from components executing in the virtualized environment 116 in other embodiments.

In the embodiment illustrated in FIG. 2A, network packets 202A that include name resolution requests 204 are intercepted at a location in the virtualized environment 116 between the bond interface 126 and a virtual network adapter 128 (e.g., the virtual network adapter 128B in the illustrated example). In this regard, it is to be appreciated that network packets 202A that contain name resolution requests 204 might be intercepted at other locations within the virtualized environment 116 in other embodiments. For example, network packets 202A that contain name resolution requests 204 might be intercepted at a location between the virtual Wi-Fi® interface 124 and the bond interface 126 in another embodiment.

As shown in FIG. 2A, intercepted name resolution requests 204 are forwarded from the virtualized environment 116 to the host OS 108. For example, in the illustrated embodiment the name resolution daemon 206 forwards packets 202A that contain name resolution requests 204 to the GNS proxy 111.

A component in the host OS 108 then spawns a user process 208 in a user session 210 that requests that the host OS 108 resolve the name specified by the intercepted name resolution request 204. For example, in the illustrated embodiment the GNS proxy 111 has spawned the user process 208, which requests resolution of the name specified in the name resolution request 204 by making an API call 212 to a name resolution API 214 provided by the host OS 108.

The name resolution API 214, in turn, performs name resolution to identify the network address corresponding to the name specified by the name resolution request 204. In an embodiment, the name resolution API 214 applies a host name resolution policy 216 when processing name resolution requests 204. The embodiments disclosed herein ensure that the same policy is applied to name resolution requests 204 originating from within the virtualized environment 116 and those originating from components executing on the host OS 108.

The host name resolution policy 216 specifies a policy to be used by the name resolution API 214 when processing name resolution requests 204. For example, the host name resolution policy 216 might specify that a particular private DNS server is to be used for packets transmitted over a VPN interface rather than a public internet DNS server. As another example, the host name resolution policy 216 might specify that certain names are to be resolved over a VPN interface while other names are resolved over an Ethernet or Wi-Fi® interface.

In an embodiment, the host name resolution policy 216 specifies name resolution on a per-application basis. For example, the host name policy 216 might specify that name resolution requests 204 generated by a particular application 120 are to be processed in a certain manner. In this embodiment, the name resolution API 214 is configured to generate a response to the API call 212 based, at least in part, on the host name resolution policy 216 and a unique identifier associated with the application 120 executing in the virtualized environment 116 that made the name resolution request 204.

In this regard, it is to be appreciated that the host name resolution policy 216 might be applied on a per-user account basis, a per-application basis, a per-interface basis, or another basis, according to various embodiments. The host name resolution policy 216 can define other types of policy for use when processing name resolution requests 204 in other embodiments.

In an embodiment, the user process 208 is executed in a user session 210 associated with the user account that was utilized to execute the component in the virtualized environment 116 that generated the name resolution request 204. This enables a user account-specific host name resolution policy 216 to be applied to name resolution requests 204 generated by components executing in the virtualized environment 116 in the same way that it would be applied to name resolution requests 204 made by components executing directly on the host 100.

FIG. 2B is a computing system architecture diagram showing aspects of a mechanism disclosed herein for generating a response to a name resolution request 204 on the host 100 and returning the response to a requesting component executing in the virtualized environment 116, according to an embodiment. As shown in FIG. 2B and described briefly above, the name resolution API 214 generates a response 226 to the API call 212 (shown in FIG. 2A) that includes the network address corresponding to the name specified by the original name resolution request 204. The name resolution API 214 then provides the response 226 to the user process 208.

Once the user process 208 has received the response 226 to the name resolution request made to the host OS 108, a response 228 to the original name resolution request 204 can be generated based on the response 226. For example, in the illustrated embodiment the GNS proxy 111 generates a network packet 202B that includes a response 228 to the original name resolution request 204, including the resolved network address set forth in the response 226.

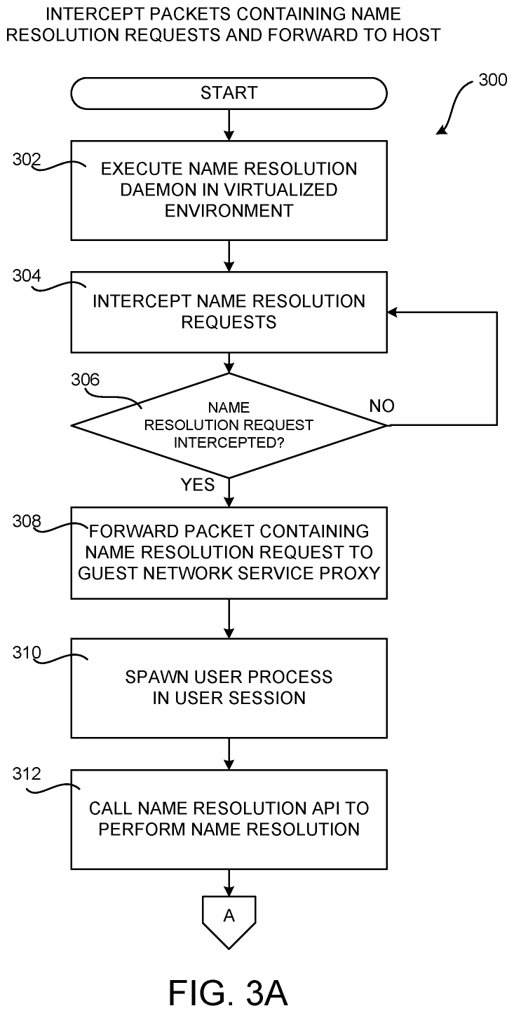

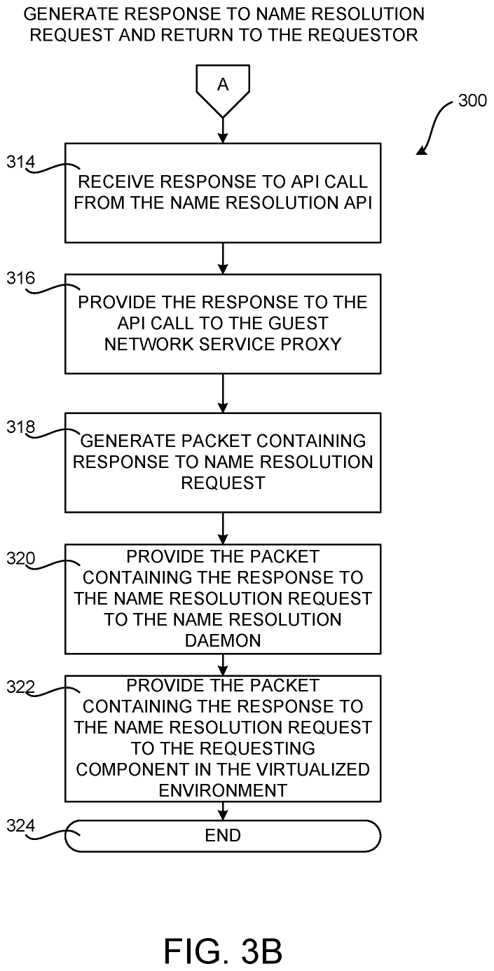

The network packet 202B can then be provided to the component executing in the virtualized environment 116 that requested name resolution in response to the original name resolution request 204. For instance, in the illustrated embodiment the GNS proxy 111 provides the network packet 202B, including the response 228 to the name resolution request 204, to the name resolution daemon 206. The name resolution daemon 206, in turn, provides the packet 202B to the requesting component, in this case one of the applications 120. Additional details regarding these aspects will be provided below with respect to FIGS. 3A and 3B.

FIGS. 3A and 3B are flow diagrams showing a routine 300 that illustrates aspects of the mechanism shown in FIG. 2A for intercepting network packets 202A generated by a component executing in a virtualized environment 116 that contain name resolution requests 204 and forwarding the network packets 202A to a host OS 108. The routine 300 also illustrates aspects of the mechanism shown in FIG. 2B for generating a response 228 to a name resolution request 204 on the host 100 and returning the response 228 to the component executing in the virtualized environment 116 that requested name resolution.

The routine 300 begins at operation 302, where the name resolution daemon 206 is executed in the virtualized environment 116 in an embodiment. The routine 300 then proceeds from operation 302 to operation 304, where the name resolution daemon 206 intercepts name resolution requests 204. As discussed above, the name resolution daemon 206 intercepts packets 202A containing name resolution requests 204 generated by other components executing within the virtualized environment 116, such as applications 120, services, or components of the guest OS 118.

By intercepting the name resolution requests 204, the name resolution daemon 206 prevents the host OS 108, a network service, or another component from responding to the name resolution requests 204. In this regard, it is to be appreciated that while a daemon is utilized in the illustrated embodiment to intercept name resolution requests 204, other types of components might be utilized in other embodiments.

The routine 300 proceeds from operation 304 to operation 306, where the name resolution daemon 206 determines whether a packet 202A containing a name resolution request 204 has been intercepted. If not, the routine 300 proceeds back to operation 304, where the name resolution daemon 206 continues evaluating network packets to determine if they contain a name resolution request 204. Network packets that do not contain name resolution requests 204 are allowed to proceed out the selected virtual network adapter 128 un-modified.

If, at operation 306, the name resolution daemon 206 determines that a packet 202A containing a name resolution request 204 has been intercepted, the routine 300 proceeds from operation 306 to operation 308. At operation 308, the name resolution daemon 206 forwards the intercepted packet 202A to the GNS proxy 111 in an embodiment. In this regard, it is to be appreciated that other types of components might be utilized in other embodiments to perform the functionality described herein as being performed by the GNS proxy 111.

From operation 308, the routine 300 proceeds to operation 310, where the GNS proxy 111 spawns a user process 208. As discussed above, in an embodiment the user process 208 is executed in a user session 210 associated with the user account used to execute the component in the virtualized environment 116 that generated the name resolution request 204. This enables a user account-specific host name resolution policy 216 to be applied to name resolution requests 204 generated by components executing in the virtualized environment 116 in the same way that it would be applied to name resolution requests 204 made by components executing directly on the host 100.

From operation 310, the routine 300 then proceeds to operation 312, where the user process 208 requests resolution of the name specified in the name resolution request 204 by making an API call 212 to the name resolution API 214 provided by the host OS 108 in an embodiment. The name resolution API 214, in turn, performs name resolution to identify the network address corresponding to the name specified by the name resolution request 204. As discussed above, the name resolution API 214 might apply the host name resolution policy 216 when processing name resolution requests 204.

From operation 312, the routine 300 proceeds to operation 314, where the user process 208 receives a response 226 to the API call 212 that includes the network address corresponding to the name specified by the original name resolution request 204 if name resolution was successful. If name resolution was not successful, the response 226 to the API call 212 may include an error code. The routine 300 then proceeds from operation 314 to operation 316, where the user process 208 provides the response 226 to the GNS proxy 111.

From operation 316, the routine 300 proceeds to operation 318, where the GNS proxy 111 generates a network packet 202B that includes a response 228 to the original name resolution request 204. If name resolution is successful, the network packet 202B includes the resolved network address set forth in the response 226 received from the name resolution API 214. If name resolution is unsuccessful, the GNS proxy 111 generates a network packet 202B that includes a translation of the error code received in response to the API call 212 into the corresponding protocol of the original name resolution request 204. The GNS proxy 111 then provides the network packet 202B, including the response 228 to the name resolution request 204, to the name resolution daemon 206 at operation 320.

The name resolution daemon 206, in turn, provides the packet 202B to the requesting component (e.g., one of the applications 120 in the illustrated embodiment) in the virtualized environment 116 at operation 322. The routine 300 then proceeds from operation 322 to operation 324, where it ends.

FIG. 4 is a computer architecture diagram showing an illustrative computer hardware and software architecture for a processing system 400 that can implement the various technologies presented herein. In particular, the architecture illustrated in FIG. 4 can be utilized to implement a host 100 capable of providing aspects of the functionality disclosed herein.

The processing system 400 illustrated in FIG. 4 includes a central processing unit 402 (“CPU”), a system memory 404, including a random-access memory 406 (“RAM”) and a read-only memory (“ROM”) 408, and a system bus 410 that couples the system memory 404 to the CPU 402. A firmware (not shown in FIG. 4) containing the basic routines that help to transfer information between elements within the processing system 400, such as during startup, can be stored in the ROM 408.

The processing system 400 further includes a mass storage device 412 for storing an operating system 422, such as the host OS 108, application programs, and other types of programs, some of which have been described herein. The mass storage device 412 can also be configured to store other types of programs and data.

The mass storage device 412 is connected to the CPU 402 through a mass storage controller (not shown in FIG. 4) connected to the bus 410. The mass storage device 412 and its associated computer readable media provide non-volatile storage for the processing system 400. Although the description of computer readable media contained herein refers to a mass storage device, such as a hard disk, Compact Disk Read-Only Memory (“CD-ROM”) drive, Digital Versatile Disc-Ready Only Memory (“DVD-ROM”) drive, or Universal Serial Bus (“USB”) storage key, it should be appreciated by those skilled in the art that computer readable media can be any available computer-readable storage media or communication media that can be accessed by the processing system 400.

Communication media includes computer-readable instructions, data structures, program modules, or other data in a modulated data signal such as a carrier wave or other transport mechanism and includes any delivery media. The term “modulated data signal” means a signal that has one or more of its characteristics changed or set in a manner so as to encode information in the signal. By way of example, communication media includes wired media such as a wired network or direct-wired connection, and wireless media such as acoustic, radio frequency, infrared and other wireless media. Combinations of the any of the above are also included within the scope of computer-readable media.

By way of example, computer-readable storage media can include volatile and non-volatile, removable and non-removable media implemented in any method or technology for storage of information such as computer readable instructions, data structures, program modules or other data. For example, computer-readable storage media includes RAM, ROM, erasable programmable ROM (“EPROM”), electrically EPROM (“EEPROM”), flash memory or other solid-state memory technology, CD-ROM, DVD-ROM, HD-DVD, BLU-RAY®, or other optical storage, magnetic cassettes, magnetic tape, magnetic disk storage or other magnetic storage devices, or any other medium that can be used to store the desired information and which can be accessed by the processing system 400. For purposes of the claims, the phrase “computer-readable storage medium,” and variations thereof, does not include waves or signals per se or communication media.

According to various configurations, the processing system 400 can operate in a networked environment using logical connections to remote computers 405 through a network such as the network 106. The processing system 400 can connect to the network 106 through a network interface unit 416 connected to the bus 410. It should be appreciated that the network interface unit 416 can also be utilized to connect to other types of networks and remote computer systems.

The processing system 400 can also include an input/output controller 418 for receiving and processing input from a number of other devices, including a keyboard, mouse, touch input, an electronic stylus (none of which are shown in FIG. 4), or a physical sensor 424, such as a video camera. Similarly, the input/output controller 418 can provide output to a display screen or other type of output device (also not shown in FIG. 4).

It should be appreciated that the software components described herein, when loaded into the CPU 402 and executed, can transform the CPU 402 and the overall processing system 400 from a general-purpose computing device into a special-purpose processing system customized to facilitate the functionality presented herein. The CPU 402 can be constructed from any number of transistors or other discrete circuit elements, which can individually or collectively assume any number of states.

More specifically, the CPU 402 can operate as a finite-state machine, in response to executable instructions contained within the software modules disclosed herein. These computer-executable instructions can transform the CPU 402 by specifying how the CPU 402 transitions between states, thereby transforming the transistors or other discrete hardware elements constituting the CPU 402.

Encoding the software modules presented herein can also transform the physical structure of the computer readable media presented herein. The specific transformation of physical structure depends on various factors, in different implementations of this description. Examples of such factors include, the technology used to implement the computer readable media, whether the computer readable media is characterized as primary or secondary storage, and the like.

For example, if the computer readable media is implemented as semiconductor-based memory, the software disclosed herein can be encoded on the computer readable media by transforming the physical state of the semiconductor memory. For instance, the software can transform the state of transistors, capacitors, or other discrete circuit elements constituting the semiconductor memory. The software can also transform the physical state of such components in order to store data thereupon.

As another example, the computer readable media disclosed herein can be implemented using magnetic or optical technology. In such implementations, the program components presented herein can transform the physical state of magnetic or optical media, when the software is encoded therein. These transformations can include altering the magnetic characteristics of particular locations within given magnetic media. These transformations can also include altering the physical features or characteristics of particular locations within given optical media, to change the optical characteristics of those locations. Other transformations of physical media are possible without departing from the scope and spirit of the present description, with the foregoing examples provided only to facilitate this discussion.

In light of the above, it should be appreciated that many types of physical transformations take place in the processing system 400 in order to store and execute the software components presented herein. It also should be appreciated that the architecture shown in FIG. 4 for the processing system 400, or a similar architecture, can be utilized to implement other types of computing devices, including hand-held computers, video game devices, embedded computer systems, mobile devices such as smartphones, tablets, alternate reality (“AR”), mixed reality (“MR”), and virtual reality (“VR”) devices, and other types of computing devices known to those skilled in the art. It is also contemplated that the processing system 400 might not include all of the components shown in FIG. 4, can include other components that are not explicitly shown in FIG. 4, or can utilize an architecture completely different than that shown in FIG. 4.

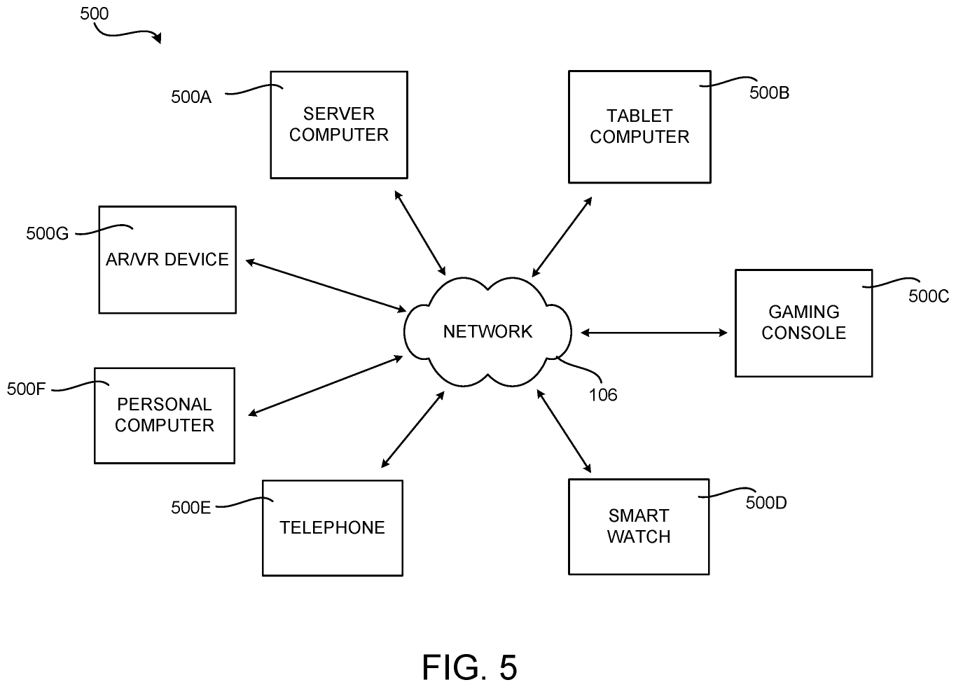

FIG. 5 is a network diagram illustrating a distributed network computing environment 500 in which aspects of the disclosed technologies can be implemented, according to various embodiments presented herein. As shown in FIG. 5, one or more server computers 500A can be interconnected via a network 106 (which may be either of, or a combination of, a fixed-wire or WLAN, wide-area network (“WAN”), intranet, extranet, peer-to-peer network, VPN, the internet, Bluetooth® communications network, proprietary low voltage communications network, or other communications network) with a number of client computing devices such as a tablet computer 500B, a gaming console 500C, a smart watch 500D, a telephone 500E, such as a smartphone, a personal computer 500F, and an AR/VR device 500G.

In a network environment in which the network 106 is the internet, for example, the server computer 500A can be a dedicated server computer operable to process and communicate data to and from the client computing devices 500B-500G via any of a number of known protocols, such as, hypertext transfer protocol (“HTTP”), file transfer protocol (“FTP”), or simple object access protocol (“SOAP”).

Additionally, the network computing environment 500 can utilize various data security protocols such as secured socket layer (“SSL”) or pretty good privacy (“PGP”). Each of the client computing devices 500B-500G can be equipped with an OS operable to support one or more computing applications or terminal sessions such as a web browser (not shown in FIG. 5), graphical UI, or a mobile desktop environment (not shown in FIG. 5) to gain access to the server computer 500A.

The server computer 500A can be communicatively coupled to other computing environments (not shown in FIG. 5) and receive data regarding a participating user's interactions. In an illustrative operation, a user (not shown in FIG. may interact with a computing application running on a client computing device 500B-500G to obtain desired data and/or perform other computing applications.

The data and/or computing applications may be stored on the server 500A, or servers 500A, and communicated to cooperating users through the client computing devices 500B-500G over the network 106. A participating user (not shown in FIG. 5) may request access to specific data and applications housed in whole or in part on the server computer 500A. These data may be communicated between the client computing devices 500B-500G and the server computer 500A for processing and storage.

The server computer 500A can host computing applications, processes and applets for the generation, authentication, encryption, and communication of data and applications such as those described above with regard to FIGS. 1-3B, and may cooperate with other server computing environments (not shown in FIG. 5), third party service providers (not shown in FIG. 5), network attached storage (“NAS”) and storage area networks (“SAN”) to realize application/data transactions.

It should be appreciated that the computing architecture shown in FIG. 4 and the distributed network computing environment shown in FIG. 5 have been simplified for ease of discussion. It should also be appreciated that the computing architecture and the distributed computing network can include and utilize many more computing components, devices, software programs, networking devices, and other components not specifically described herein.

While the subject matter described above has been presented in the general context of computing devices implementing virtualized environments, such as VMs and containers, those skilled in the art will recognize that other implementations can be performed in combination with other types of computing devices, systems, and modules. Those skilled in the art will also appreciate that the subject matter described herein can be practiced with other computer system configurations, including hand-held devices, multiprocessor systems, microprocessor-based or programmable consumer electronics, computing or processing systems embedded in devices (such as wearable computing devices, automobiles, home automation, etc.), minicomputers, mainframe computers, and the like.

It is to be further understood that the operations of the routines and methods disclosed herein are not presented in any particular order and that performance of some or all of the operations in an alternative order, or orders, is possible and is contemplated. The operations have been presented in the demonstrated order for ease of description and illustration. Operations may be added, omitted, and/or performed simultaneously, without departing from the scope of the appended claims. The illustrated routines and methods can end at any time and need not be performed in their entireties.

Some or all operations of the methods, and/or substantially equivalent operations, can be performed by execution of computer-readable instructions included on a computer-readable storage media, as defined herein. The term “computer-readable instructions,” and variants thereof, as used in the description and claims, is used expansively herein to include routines, applications, application modules, program modules, programs, components, data structures, algorithms, and the like. Computer-readable instructions can be implemented on various system configurations, including single-processor or multiprocessor systems, minicomputers, mainframe computers, personal computers, hand-held computing devices, microprocessor-based, programmable consumer electronics, combinations thereof, and the like.

Thus, it should be appreciated that the logical operations described herein are implemented (1) as a sequence of computer implemented acts or program modules running on a computing system and/or (2) as interconnected machine logic circuits or circuit modules within the computing system. The implementation is a matter of choice dependent on the performance and other requirements of the computing system. Accordingly, the logical operations described herein are referred to variously as states, operations, structural devices, acts, or modules. These operations, structural devices, acts, and modules may be implemented in software, in firmware, in special purpose digital logic, and any combination thereof.

For example, the operations illustrated in the sequence and flow diagrams and described herein can be implemented, at least in part, by modules implementing the features disclosed herein and can be a dynamically linked library (“DLL”), a statically linked library, functionality produced by an API, a network service, a compiled program, an interpreted program, a script or any other executable set of instructions. Data can be stored in a data structure in one or more memory components. Data can be retrieved from the data structure by addressing links or references to the data structure.

It can be further appreciated that the methods and routines described herein may be also implemented in many other ways. For example, the routines and methods may be implemented, at least in part, by a processor of another remote computer or a local circuit. In addition, one or more of the operations of the routines or methods may alternatively or additionally be implemented, at least in part, by a chipset working alone or in conjunction with other software modules.

The disclosure presented herein also encompasses the subject matter set forth in the following clauses:

Clause 1. A computer-implemented method, comprising: intercepting a first network packet generated by an application executing in a virtualized environment provided by a host processing system, the first network packet comprising a request to resolve a name; generating an application programming interface (API) call to a name resolution API, the name resolution API provided by a host operating system (OS) executing on the host processing system; receiving a response to the API call; generating a second network packet comprising a response to the request to resolve the name based, at least in part, on the response to the API call; and providing the second network packet to the application.

Clause 2. The computer-implemented method of clause 1, wherein the name resolution API is configured to generate the response to the API call based, at least in part, on a name resolution policy.

Clause 3. The computer-implemented method of any of clauses 1 or 2, wherein the name resolution API is configured to generate the response to the API call based, at least in part, on a name resolution policy and an identifier associated with the application executing in the virtualized environment.

Clause 4. The computer-implemented method of any of clauses 1-3, wherein the API call to the name resolution API is generated in association with a user account used to execute the application in the virtualized environment.

Clause 5. The computer-implemented method of any of clauses 1-4, wherein the first network packet is intercepted at a location in the virtualized environment between a bond interface and a virtual network adapter.

Clause 6. The computer-implemented method of any of clauses 1-5, wherein the first network packet is intercepted based, at least in part, upon a protocol and a port number specified by the first network packet.

Clause 7. The computer-implemented method of any of clauses 1-6, wherein the first network packet is intercepted based, at least in part, upon a guest name resolution policy defined by a guest OS executing in the virtualized environment.

Clause 8. A computer-readable storage medium having computer-executable instructions stored thereupon that, when executed by a processing system, cause the processing system to: intercept a request to resolve a name from a component executing within a virtualized environment provided by the processing system; forward the request from the virtualized environment to an operating system executing on the processing system; execute a user process on the processing system to request resolution of the name from the operating system executing on the processing system; and provide a response to the request to the component executing within the virtualized environment based on a response received from the user process.

Clause 9. The computer-readable storage medium of clause 8, wherein the user process requests resolution of the name by making an application programming interface (API) call to a name resolution API provided by the operating system executing on the processing system, the name resolution API configured to generate a response to the API call based, at least in part, on a name resolution policy.

Clause 10. The computer-readable storage medium of any of clauses 8 or 9, wherein the name resolution API is further configured to generate the response to the API call based, at least in part, on an identifier associated with the component executing within the virtualized environment.

Clause 11. The computer-readable storage medium of any of clauses 8-10, wherein the API call to the name resolution API is made in association with a user account that was used to execute the component within the virtualized environment.

Clause 12. The computer-readable storage medium of any of clauses 8-11, wherein the request is intercepted at a location in the virtualized environment between a bond interface and a virtual network adapter.

Clause 13. The computer-readable storage medium of any of clauses 8-12 wherein the request is intercepted based, at least in part, upon a protocol and a port number specified by a network packet comprising the request.

Clause 14. The computer-readable storage medium of any of clauses 8-13, wherein the request is intercepted based, at least in part, upon a guest name resolution policy defined by a guest operating system executing in the virtualized environment.

Clause 15. A processing system, comprising: a processor; and a computer-readable storage medium having computer-executable instructions stored thereupon that, when executed by the processing system, cause the processing system to: intercept a request to resolve a name from a component executing within a virtualized environment; forward the request to resolve the name from the virtualized environment to a host operating system; execute a user process configured to request resolution of the name from the host operating system; and provide a response to the request to resolve the name received from the component executing within the virtualized environment based on a response received from the user process.

Clause 16. The processing system of clause 15, wherein the user process requests resolution of the name by making an application programming interface (API) call to a name resolution API provided by the host operating system, the name resolution API configured to generate a response to the API call based, at least in part, on a name resolution policy.

Clause 17. The processing system of any of clauses 15 or 16, wherein the name resolution API is further configured to generate the response to the API call based, at least in part, on an identifier associated with the component executing in the virtualized environment.

Clause 18. The processing system of any of clauses 15-17, wherein the API call to the name resolution API is made in association with a user account that was used to execute the component within the virtualized environment.

Clause 19. The processing system of any of clauses 15-18, wherein the request to resolve the name is intercepted based, at least in part, upon a protocol and a port number specified by a network packet comprising the request to resolve the name.

Clause 20. The processing system of any of clauses 15-19, wherein the request to resolve the name is intercepted based, at least in part, upon a guest name resolution policy defined by a guest operating system executing in the virtualized environment.

Based on the foregoing, it should be appreciated that technologies for providing name resolution services to components executing in a virtualized environment have been disclosed herein. Although the subject matter presented herein has been described in language specific to computer structural features, methodological and transformative acts, specific computing machinery, and computer readable media, it is to be understood that the subject matter set forth in the appended claims is not necessarily limited to the specific features, acts, or media described herein. Rather, the specific features, acts and mediums are disclosed as example forms of implementing the claimed subject matter.

The subject matter described above is provided by way of illustration only and should not be construed as limiting. Various modifications and changes can be made to the subject matter described herein without following the example configurations and applications illustrated and described, and without departing from the scope of the present disclosure, which is set forth in the following claims.

What is claimed is:

1. A computer-implemented method, comprising:
intercepting a first network packet generated by an application executing in a virtualized environment provided by a host processing system, the first network packet comprising a request to resolve a name;
generating an application programming interface (API) call to a name resolution API, the name resolution API provided by a host operating system (OS) executing on the host processing system;
receiving a response to the API call;
generating a second network packet comprising a response to the request to resolve the name based, at least in part, on the response to the API call; and
providing the second network packet to the application.

2. The computer-implemented method of claim 1, wherein the name resolution API is configured to generate the response to the API call based, at least in part, on a name resolution policy.

3. The computer-implemented method of claim 1, wherein the name resolution API is configured to generate the response to the API call based, at least in part, on a name resolution policy and an identifier associated with the application executing in the virtualized environment.

4. The computer-implemented method of claim 1, wherein the API call to the name resolution API is generated in association with a user account used to execute the application in the virtualized environment.

5. The computer-implemented method of claim 1, wherein the first network packet is intercepted at a location in the virtualized environment between a bond interface and a virtual network adapter.

6. The computer-implemented method of claim 1, wherein the first network packet is intercepted based, at least in part, upon a protocol and a port number specified by the first network packet.

7. The computer-implemented method of claim 1, wherein the first network packet is intercepted based, at least in part, upon a guest name resolution policy defined by a guest OS executing in the virtualized environment.

8. A computer-readable storage medium having computer-executable instructions stored thereupon that, when executed by a processing system, cause the processing system to:
intercept a request to resolve a name from a component executing within a virtualized environment provided by the processing system;
forward the request from the virtualized environment to an operating system executing on the processing system;
execute a user process on the processing system to request resolution of the name from the operating system executing on the processing system; and
provide a response to the request to the component executing within the virtualized environment based on a response received from the user process.

9. The computer-readable storage medium of claim 8, wherein the user process requests resolution of the name by making an application programming interface (API) call to a name resolution API provided by the operating system executing on the processing system, the name resolution API configured to generate a response to the API call based, at least in part, on a name resolution policy.

10. The computer-readable storage medium of claim 9, wherein the name resolution API is further configured to generate the response to the API call based, at least in part, on an identifier associated with the component executing within the virtualized environment.

11. The computer-readable storage medium of claim 9, wherein the API call to the name resolution API is made in association with a user account that was used to execute the component within the virtualized environment.

12. The computer-readable storage medium of claim 8, wherein the request is intercepted at a location in the virtualized environment between a bond interface and a virtual network adapter.

13. The computer-readable storage medium of claim 8, wherein the request is intercepted based, at least in part, upon a protocol and a port number specified by a network packet comprising the request.

14. The computer-readable storage medium of claim 8, wherein the request is intercepted based, at least in part, upon a guest name resolution policy defined by a guest operating system executing in the virtualized environment.

15. A processing system, comprising:
a processor; and
a computer-readable storage medium having computer-executable instructions stored thereupon that, when executed by the processing system, cause the processing system to:
intercept a request to resolve a name from a component executing within a virtualized environment;
forward the request to resolve the name from the virtualized environment to a host operating system;
execute a user process configured to request resolution of the name from the host operating system; and
provide a response to the request to resolve the name received from the component executing within the virtualized environment based on a response received from the user process.

16. The processing system of claim 15, wherein the user process requests resolution of the name by making an application programming interface (API) call to a name resolution API provided by the host operating system, the name resolution API configured to generate a response to the API call based, at least in part, on a name resolution policy.

17. The processing system of claim 16, wherein the name resolution API is further configured to generate the response to the API call based, at least in part, on an identifier associated with the component executing in the virtualized environment.

18. The processing system of claim 15, wherein the API call to the name resolution API is made in association with a user account that was used to execute the component within the virtualized environment.

19. The processing system of claim 15, wherein the request to resolve the name is intercepted based, at least in part, upon a protocol and a port number specified by a network packet comprising the request to resolve the name.

20. The processing system of claim 15, wherein the request to resolve the name is intercepted based, at least in part, upon a guest name resolution policy defined by a guest operating system executing in the virtualized environment.
